(19) United States
(12) Patent Application Publication
(10) Pub. No.: US 2020/0368990 A1
(43) Pub. Date: Nov. 26, 2020

(54) PAPER STRAW MANUFACTURE

(71) Applicant: Tipi Eco Ltd, Llandilo Graban (GB)

(72) Inventor: Jacqui Horton, Llandilo Graban (GB)

(21) Appl. No.: 16/933,367

(22) Filed: Jul. 20, 2020

(30) Foreign Application Priority Data
May 20, 2019 (GB) 1907103.4

(51) Int. Cl. B31D 5/00; A47G 21/18

(52) U.S. Cl. CPC B31D 5/0095; A47G 2400/10; A47G 21/18

(57) ABSTRACT

A method of manufacturing a bendable paper straw and a paper straw made in accordance with the method, the method including the steps, in any convenient order, of coating plies of flexible material, such as paper, with a generally liquid adhesive, such as food grade glue, forming on a mandrel having a generally smooth outer surface a tube composed of a plurality of plies of such coated flexible material, such as helically-wound plies, if necessary, cutting the tube into lengths suitable for forming finished straws, and before the adhesive has set, mounting the or each tube on a respective mandrel having a smooth outer surface and thereafter forming a series of generally concentric grooves on the outside the tube, such as by rolling, pressing or crimping the grooves, and thereafter moving one end of the tube towards the other end along its major axis, such as by pushing or pulling, whereby to axially compress the series of grooves to form a set of annular corrugations, and thereafter allowing the adhesive to set, whereby to form a straw bendable around the corrugated region into a temporarily deformed shape.

This application claims priority to British Patent Application No. 1907103.4 filed on May 20, 2019, the disclosure of which is incorporated herein by reference.

### TECHNICAL FIELD

This invention relates to paper straws of the type used for sucking liquids from containers, such as cardboard drinks cartons, although the invention is not limited to such use.

### BACKGROUND

It is well-known that paper straws are more environmentally friendly than straws made from plastics, the latter being derived from fossil fuels such as oil that are generally not biodegradable. In contrast, straws made from paper or other organic materials are readily biodegradable and hence are less damaging to the environment. Such paper straws are traditionally continuously made on a long, smooth, mandrel onto which is helically wound several, typically three, plies of pre-glued paper, each from a respective spool of pre-cut paper, which plies are overlaid to form a long tube on the mandrel which is then cut to lengths approximating the required length of each straw. The cut lengths of tubing are then ejected from the end of the mandrel and allowed to dry to form finished straws that are relatively stiff and sufficiently waterproof for transporting liquid from a container, such as a drinks container, to the mouth of a user of the straw. Thus, once formed, paper straws are not easily amenable to further manufacturing forming processes, whereas drinking straws made from plastics have the advantage in that during manufacture and while still hot they can be easily formed to any required shape, including by forming corrugations near one end before the plastics has cooled and set, thereby allowing the finished straw to bend and make it easier for a user of the straw to drink from a vertically-orientated drinks container. However, forming corrugations in paper straws is more problematic because they are made of multiple plies of flexible but generally inelastic paper bonded together by a non-toxic, food grade, adhesive which, when dried, produces a generally stiff tube which resists any further deformation.

### SUMMARY

The foregoing problems relating to paper straws are addressed in US2019/0069701 (D1) which describes a method of making them bendable by forming annular corrugations in the tubular walls of the straw with the aid of corrugated elements spaced apart from each other in axial and radial directions relative to the major axis of the straw, which is itself mounted on a corrugated mandrel against which the straw can be pressed to form correspondingly shaped corrugations in the straw, whereafter the mandrel is withdrawn from within the corrugated straw, leaving it bendable in the region of the corrugations. However, whist such an arrangement is generally satisfactory the bendability of the straw is dependent upon the number and size of each of the corrugated elements which, in themselves, are composed of a series of deformed and indented sections corresponding to parts of the straw that are required to bend in use, like a living hinge, and intermediate undeformed tubular sections of the straw which are not intended to bend in use, in a manner similar to the carriages of a goods train where the carriages remain substantially straight and are connected by links which bend as the goods train travels over a curved section of railway track. As a consequence, with straws made in accordance with the teaching of D1 there is a practical limit to the amount by which the straw can bend, typically being only about 90° from the major axis of the straw as shown in the drawings to that prior art disclosure where nine joints are provided between ten stiff sections of straw tube. The resultant radius of curvature is therefore relatively large as compared to the overall length of the straw, taking up about a third of its length in order to achieve just a 90° bend. This makes such a straw unsuitable for use as a substitute for bendable plastics straws releasably secured to the sides of drinks cartons prior to use, because they cannot provide an 180° bend within the space available on the side of the carton.

In another method of making bendable paper straws dating from the 1930s as described in U.S. Pat. No. 2,094,268 (D2), the pre-glued paper plies are formed into a tube, allowed to dry and hence stiffen, and is then mounted on a partially-corrugated mandrel of diameter “substantially smaller” than the interior diameter of the tube, the corrugated part of the mandrel providing a bearing surface over which a correspondingly-shaped wheel may rotate and be moved towards the mandrel, between which the sidewall of the tube is trapped, to be then deformed into correspondingly shaped corrugations, whereafter the corrugated wheel is moved away from the mandrel and the partially corrugated straw is removed from the mandrel. However, once again, whilst this arrangement is possibly satisfactory for forming relatively large corrugations in paper straws (although the drawings describing the amount of corrugation possible appear somewhat exaggerated) it is rather a complicated method and the end result is still a straw with relatively modest bendability and, because of the presence of internally-extending corrugations it does not suggest that it is suitable for high-speed manufacture.

Accordingly, in the methods of manufacturing paper straws as taught by D1 and D2, both straws are unsuitable for packaging with drinks containers in the form of cardboard cartons because they cannot be bent or folded effectively back on themselves to the necessary extent, typically by 180°.

The present invention is derived from the realisation that an alternative approach to the construction of paper straws would be advantageous if it allows straws to bend by a greater extent than that taught in the processes of D1 and D2, and preferably if it allows the straws to bend to the same extent as bendable straws made from plastics, such as being bendable by up to at least 180° instead of just around 90°, and with a radius of curvature comparable with that of a plastics bendable straw.

According to a first aspect of the invention there is provided a method of manufacturing a bendable paper straw (as defined below), the method including the steps, in any convenient order, of coating plies of flexible material, such as paper, with a generally liquid adhesive, such as food grade glue, forming on a mandrel having a generally smooth outer surface a tube composed of a plurality of plies of such coated flexible material, such as helically-wound plies, if necessary, cutting the tube into lengths suitable for forming finished straws, and before the adhesive has set, mounting the or each tube on a respective mandrel having a smooth outer surface and thereafter forming a series of generally concentric grooves on the outside the tube, such as by rolling, pressing or crimping the grooves, and thereafter moving one end of the tube towards the other end along its major axis, such as by pushing or pulling, whereby to axially compress the series of grooves to form a set of annular corrugations, and thereafter allowing the adhesive to set, whereby to form a straw bendable around the corrugated region into a temporarily deformed shape.

With this arrangement, the limitations and difficulties of trying to deform or otherwise corrugate parts of an already constructed and stiff paper straw are avoided by the elegantly simple solution of forming the corrugations in the straw tube while it is still pliant and therefore sufficiently deformable within the limits of its inherent pliability while still being mounted on a mandrel or similarly shaped rod having a generally smooth outer surface i.e. not corrugated. As a consequence, a relatively large number of grooves may be formed over a relatively short section of the tube before the adhesive is allowed to dry and is then compressed axially in order to form a relatively large number of corrugations which, although each being relatively small compared to the corrugations of D1 and D2, nevertheless collectively allow the straw to be bent through at least 180° after the adhesive has set. As a consequence, such a straw is suitable for temporary attachment to the side of a drinks container for transport and storage prior to sale.

Preferably, in order to more easily facilitate the formation of the annular corrugations, the wall thickness of the paper tube is made thicker than is usual when making ordinary paper straws which do not bend, typically by being 0.5 mm thick instead of 0.35 mm, the extra thickness more easily allowing the formation of the corrugations without the risk of damage being caused to the walls of the tube.

In one arrangement, the generally concentric grooves are formed on the outer surface of the at least partially wet tube by one or more bladed rollers on an armature which press into but do not cut the outer surface of the tube. This allows the grooves to be concentric, or they may instead be formed helically as the tube is caused to spin relative thereto. In an alternative arrangement, the grooves are formed by a clamping process, such as by the use of a split die, each die half having internally matching grooves, such that when the die halves are clamped together they form concentric grooves around the tube which, on unclamping of the die halves, can then be used to form the corrugations in the tube when it is axially compressed on the mandrel before being ejected and subsequently allowed to dry.

In this patent specification the term “paper straw” is intended to include straws made of other non-plastics materials including cellulose, bamboo and other suitably pliant plant-based material. The term “straw” itself is intended to include tubes of any convenient cross-sectional shape including circular, rectilinear or elliptical.

According to a second aspect of the invention there is provided a paper straw made in accordance with the method of the first aspect of the invention.

According to a third aspect of the invention there is provided a drinks container in combination with a paper straw in accordance with the second aspect of the invention in which the straw is pre-bent to a desired angle and releasably secured to an outside surface of the container, either directly or indirectly, such as in a sealed sachet.

### BRIEF DESCRIPTION OF THE DRAWING FIGURES

The invention will now be described, by way of example only, with reference to the accompanying drawings in which:

FIG. 1 is a view of a prior art bendable paper straw in accordance with D1,

FIG. 2 is a view of the paper straw of FIG. 1 in which the top end is bent at right-angles for use,

FIG. 3 is a schematic view of a 3-ply paper tube formed on a smoothly-surfaced mandrel,

FIG. 4 is a view of part of a cut length of part of the paper tube of FIG. 3 onto which has been formed a series of grooves,

FIG. 5 is a view of the part of the tube shown in FIG. 4 after being axially compressed to form a series of corrugations,

FIG. 6 is a view of a finished straw in which the drinking end has been folded through 180° via the corrugations of FIG. 5, and

FIG. 7 shows the finished straw of FIG. 6 temporarily secured to the side of a drinks container.

### DETAILED DESCRIPTION

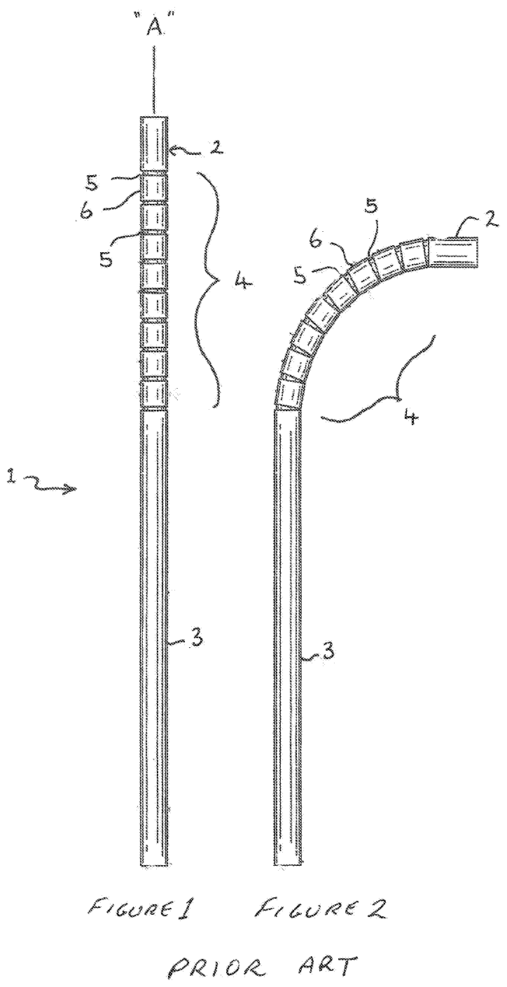

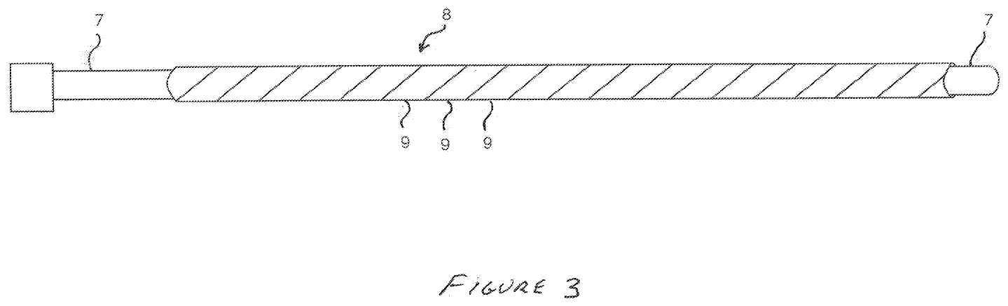

Referring firstly to FIGS. 1 and 2 there is shown a prior art tubular paper straw 1 as taught by D1, the straw having an upper, drinking, end 2 for insertion between the lips of a user of the straw (not shown), a lower, dipping, end 3 for insertion into a drinks container (not shown). Immediately below the upper end 2 is a bendable section 4 having a series of nine crimped joints 5, between respective pairs of which are undeformed tubular segments 6 of the straw 1, the arrangement therefore allowing the upper end 2 of the straw 1 to be bent at approximately 90° to the major axis “A” of the straw in the manner as shown in FIG. 2. As explained in the teaching of D1, the formation of the joints 5 requires a fairly complicated arrangement involving several machines, the first for forming tubes from helically-wound plies of paper secured together with a suitable food-grade adhesive which, after drying, produces a stiff but waterproof tube which is then cut into lengths corresponding to individual straw blanks. Each tubular straw blank is then mounted on a corrugated mandrel in a corrugation machine which deforms part of it at spaced intervals by forming the joints 5 which thereafter act as living hinges, allowing limited angular movement between respective pairs of stiff tube segments 6. As a consequence of the stiffness of the tube segments 6 and the need to form corrugations therebetween at regular intervals along the length, which intervals correspond to the corrugations in the corrugation mandrel, they collectively impose a practical upper limit on the amount of joints 5 that may be provided in the finished straw 1 which, in turn, imposes a practical limit on the amount by which the straw can be bent. This prior art straw is therefore somewhat complicated to make and has limited bendability, only achieving a 90° bend by using roughly a third of the length of the entire straw.

In contrast to the prior art paper straw as taught by D1, the present invention provides a paper straw which is relatively easy to make, requiring no corrugated mandrel, and in which the corrugations can be much more numerous per unit length of straw in the relevant region. This is achieved by adopting a different approach to the conventional one of forming corrugations after formation of a stiff straw blank.

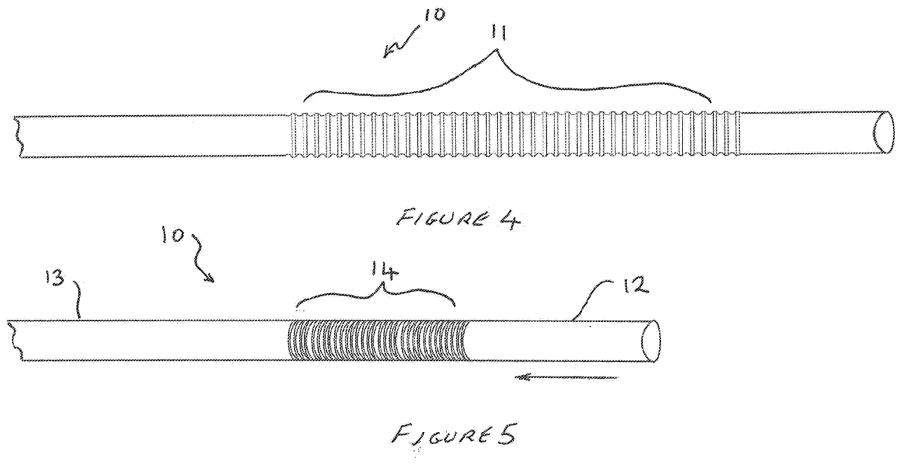

In accordance with the method of the invention and as shown in FIG. 3, a smooth mandrel 7 is used on which to form a correspondingly smooth-bored tube 8 made from helically-wound plies of paper 9, typically a layer of three overlapping plies, the plies being pre-coated with a suitable food-grade liquid adhesive such as AQUENCE BG 9040 LM supplied by Henkel AG. The length of the tube 8 is sufficient to be cut into several straw blanks 10, the end of one of which is shown in FIG. 4, which, before the adhesive has dried, is provided with a set of concentric finely-pitched grooves 11 in a manner to be described.

As shown in FIG. 5 the drinking end 12 of the straw blank 10 is then moved towards the dipping end 13, by pulling or pushing in the direction arrowed, whereupon a set of finely-pitched corrugations 14 is formed as a consequence of the presence of the grooves 11, the axial length of the straw blank 10 thereby being correspondingly reduced. By way of specific example, if the grooves 11, typically around 40 grooves, are formed over a length of 50 mm on the straw blank 10 and subsequently axially compressed to form corrugations 14 the length of the finished straw is typically reduced by around 15 mm.

In practice it has been found to be preferable to form a wet straw tube in accordance with the method of the invention with a wall thickness greater than is usually the case when making non-bendable paper straws, such that instead of the walls typically being 0.35 mm thick as is conventionally the case, by making the wall thickness 0.50 mm or some other suitably increased thickness, the additional material allows it to be more easily formed into corrugations without the risk of damage that may otherwise occur with walls of standard thickness, especially when they are not fully dried. It is to be expected that such additional wall thickness and the need therefor will depend upon the type of material used to construct the paper straw, as well as variations in the diameter or shape of the tube.

As will be appreciated, although the size of the corrugations 14 is relatively small as compared to the much more pronounced corrugations of D1 and D2, their number is relatively great, typically 40 such small corrugations over a distance of 35 mm of finished tube length, compared to the relatively few corrugations spread over a large distance as taught in D1. This large number of small corrugations 14 means that after the straw blank 10 has been dried and become stiff, the corrugated part can be easily bent to almost any angle up to around 270° from its major axis.

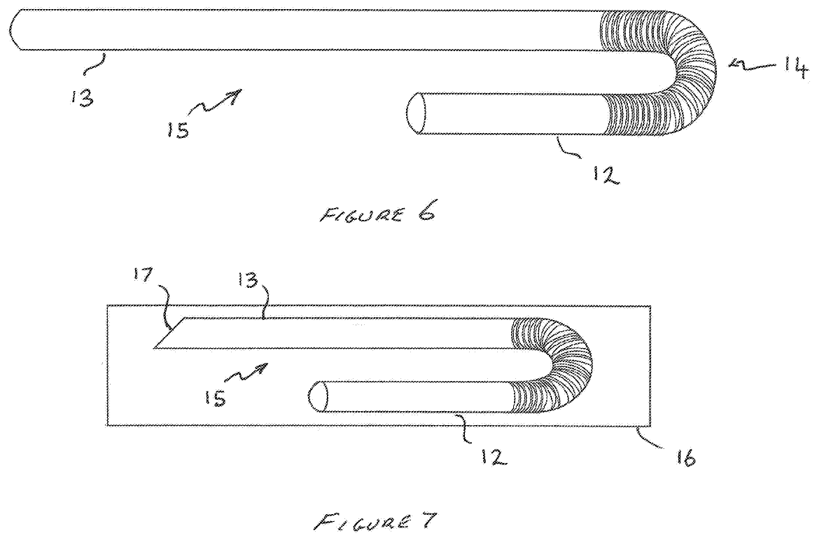

FIG. 6 shows the finished straw 15 in which the drinking end 12 has been bent through 180° relative to the major axis of the dipping end 13, this being made possible by virtue of the presence of the corrugations 14. Whilst being a considerable improvement over the bendability of the straws taught by D1 and D2, it has been found in practice that the dipping end 12 can be bent by up to 270°, although this is generally not a requirement for such bendable straws. Nevertheless, it illustrates that the mechanical performance of the straw 15 is able to substantially match the mechanical performance of a bendable plastics straw, over which it has the obvious advantage of being biodegradable.

FIG. 7 shows the finished and folded straw 15 releasably mounted on the side of a drinks container 16, such as by being stored within an openable paper sachet (not shown) or simply by being secured directly thereto by means of a suitably light adhesive. The drinking end 12 has been bent through 180° prior to packaging and upon removal from the side of the drinks container 16 can be further bent to any desired angle in the same way as a bendable plastics straw. As such, the finished straw 15 represents a direct and easily manufactured replacement for such a bendable plastic straw whilst having essentially the same functionality.

In accordance with a refinement to the invention and as also shown In FIG. 7, the dipping end 13 of the straw 15 is provided with a sharply defined blade 17 at 45° from the major axis of the straw 15 such that the blade 17 can be used to pierce an otherwise sealed opening (not shown) in the container 16. The blade 17 is suitably formed before the straw blank 10 is dry and while still supported on a mandrel such that the walls of the dipping end 13 are supported as it is cut.

A further benefit of the invention arises due to the simplicity of manufacture, which does not require differently-shaped mandrels, one for forming a smooth-bored tube capable of supplying a number of straw blanks and another for forming corrugations in individual straw blanks after they have dried. Instead, the entire forming process can be performed on mandrels having smooth outer surfaces and a cross-section of shape and size substantially corresponding to the inside of the finished straw. This has significant cost-saving advantages over mandrels that are formed with corrugations, which are expensive to make and, necessarily, prevent them from easily ejecting the finished straw in the axial direction.

1. A method of manufacturing a bendable paper straw (as defined below), the method including the steps, in any convenient order, of coating plies of flexible material, such as paper, with a generally liquid adhesive, such as food grade glue, forming on a mandrel having a generally smooth outer surface a tube composed of a plurality of plies of such coated flexible material, such as helically-wound plies, if necessary, cutting the tube into lengths suitable for forming finished straws, and before the adhesive has set, mounting the or each tube on a respective mandrel having a smooth outer surface and thereafter forming a series of generally concentric grooves on the outside the tube, such as by rolling, pressing or crimping the grooves, and thereafter moving one end of the tube towards the other end along its major axis, such as by pushing or pulling, whereby to axially compress the series of grooves to form a set of annular corrugations, and thereafter allowing the adhesive to set, whereby to form a straw bendable around the corrugated region into a temporarily deformed shape.

2. A method according to claim 1 wherein the wall thickness of the paper tube exceeds the thickness necessary for making a stiff paper straw, the extra thickness allowing the formation of corrugations without the risk of damage being caused to the walls of the tube.

3. A method according to claim 1 wherein the generally concentric grooves are formed on the outer surface of the at least partially wet tube by one or more bladed rollers on an armature which press into but do not cut the outer surface of the tube.

4. A method according to claim 1 wherein the grooves are formed continuously i.e. helically but approaching concentrically.

5. A method according to claim 1 wherein the grooves are formed by a clamping process, such as by the use of a split die, each die half having internally matching grooves, such that when the die halves are clamped together they form concentric grooves around the tube which, on unclamping of the die halves, can then be used to form the corrugations in the tube when it is axially compressed on the mandrel before being ejected and subsequently allowed to dry.

6. A paper straw made in accordance with the method of according to claim 1.

7. A straw 15 according to claim 6 wherein the dipping end 13 of the straw is provided with a sharply defined blade 17 at 45° from the major axis of the straw 15 such that the blade 17 can be used to pierce an otherwise sealed opening in the container 16.

8. A straw according to claim 7 wherein the blade 17 is suitably formed before the straw blank 10 is dry and while still supported on a mandrel such that the walls of the dipping end 13 are supported as it is cut.

9. A drinks container 16 in combination with a paper straw in accordance with claim 6 in which the straw is pre-bent to a desired angle and releasably secured to an outside surface of the container, either directly or indirectly, such as in a sealed sachet.
